(19) United States
(12) Patent Application Publication
(10) Pub. No.: US 2003/0185344 A1
(43) Pub. Date: Oct. 2, 2003

(54) X-ray tube and X-ray generator

(75) Inventor: Masaaki Ukita, Kyoto-shi (JP)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: SHIMADZU CORPORATION, Kyoto-shi (JP)

(21) Appl. No.: 10/109,311

(22) Filed: Mar. 28, 2002

(51) Int. Cl. H01J 35/08

(52) U.S. Cl. 378/143

(57) ABSTRACT

A multilayer target 5 is composed of a first layer 5a, a second layer 5b and a third layer 5c which are made of different materials. When an electron beam 13 is incident upon the multilayer target 5, the electron beam 13 arrives at the third layer 5c, and X-rays Xₐ, X_{b} and X_{c}, the radiation qualities of which are respectively suitable for the characteristics of the first layer 5a, the second layer 5b and the third layer 5c, are generated.

### BACKGROUND OF THE INVENTION

1. Technical Field of the Invention

The present invention relates to an X-ray tube such as a transmission type micro-focus X-ray tube, which is used as an X-ray source of an X-ray non-destructive inspection apparatus or X-ray analyzer, and a soft X-ray tube. The present invention also relates to an X-ray generator including those transmission type micro-focus X-ray tube and soft X-ray tube.

2. Description of the Related Art

A transmission type X-ray tube used as an X-ray source of an X-ray non-destructive inspection apparatus or X-ray analyzer has a small focus. For example, the transmission type X-ray tube is used for an industrial X-ray apparatus to take X-ray photographs by magnifying the inner structure of LSI.

As shown in FIG. 9, a related art transmission type X-ray tube includes an evacuated housing 10, a grid electrode 11, an electron source 12, an electron lens 14, a target 15, and an X-ray transmission window 16. The evacuated housing 10 is maintained in a vacuum state. The electron source 12, the electron lens 14 and the target 15 are arranged in the evacuated housing 10. An electron beam 13 is emitted from the electron source 12 via the grid electrode 11. The thus emitted electron beam 13 is focused by the electron lens 14 and the focused electron beam irradiates to the target 15. In the target 15 irradiated with the electron beam 13, X-rays are generated. An X-ray in the thus generated X-rays, which is transmitted through the X-ray transmission window 16 on a side opposite to an incoming side of the electron beam 13, is utilized in air.

In the X-ray tube of the related art structure shown in FIG. 9, the target 15 is composed of a layer made of one type of metal such as tungsten (W), molybdenum (Mo) or copper (Cu). Therefore, the generated X-rays contain only characteristic X-rays and bremsstrahlung X-rays that are peculiar to the target material. For the above reasons, it is impossible for the related art X-ray tube to generate X-rays having various radiation qualities that are appropriate for samples to be inspected. Therefore, it is impossible to perform appropriate inspections according to the samples to be inspected.

### SUMMARY OF THE INVENTION

The present invention has been accomplished to solve the above problems of the related art. It is an object of the present invention to provide an X-ray tube and an X-ray generator capable of changing the radiation qualities of generated X-rays according to samples to be inspected so that X-rays appropriate for samples to be inspected can be generated.

In order to accomplish the object above, the following means are adopted. According to the present invention, there is provided an X-ray tube comprising an electron source for applying electrons; and a target for generating X-rays based on the electrons applied from the electron source and incident upon the target, the target including a multilayer made of different materials.

According to the above-mentioned X-ray tube, since the target is composed of a multilayer made of different materials, X-rays of different radiation qualities are generated from the respective layers.

In the X-ray tube, it is preferable that the multilayer target includes at least two layers in which one of the layers located closer to an incoming side of the electrons than the other has a melting temperature higher than that of the other of layers.

According to the above-mentioned X-ray tube, since the layer located closer to the incoming side of electrons than the other is made of metal of a high melting temperature, it is possible to prevent a metal of a low melting temperature of the layer, which is located near the incoming side of the electrons but farther from the incoming side of the electrons than the layer made of metal of the high melting temperature, from melting and vaporizing. Therefore, life of the target can be extended.

Further, in order to accomplish the object above, there is provided an X-ray generator comprising: an X-ray tube having an electron source for applying electrons, and a target for generating X-rays based on the electrons applied from the electron source and incident upon the target, the target including a multilayer made of different materials; and a high voltage generating unit for supplying a different high voltage to the electron source according to the target.

According to the X-ray generator, when an accelerating voltage of electrons irradiated to the target is appropriately changed, an incident depth of electrons into the target composed of the multilayer is changed. Therefore, the radiation qualities of generated X-rays can be variously changed.

### BRIEF DESCRIPTION OF THE DRAWINGS

FIG. 1 is a view showing an outline of an X-ray generator of an embodiment of the present invention;

FIG. 2 is a view showing an X-ray generating section of an X-ray generator of an embodiment of the present invention;

FIG. 3 is a schematic illustration for explaining a diffusion model of electrons proposed by Archard and modified by Kanaya and Okayama;

FIG. 4 is a graph showing a relation between an accelerating voltage and Rv (V) in a diffusion model;

FIG. 5 is a graph showing relations among an accelerating voltage, incident electron depth R1 and electron diffusion radius R2 in a target of copper (cu);

FIG. 6 is a graph showing relations among an accelerating voltage, incident electron depth R1 and electron diffusion radius R2 in a target of germanium (Ge);

FIGS. 7A and 7B are schematic illustrations showing an X-ray generating region and X-ray spectrum in a target;

FIGS. 8A-8C are schematic illustrations showing an X-ray generating region and X-ray spectrum in a target at each accelerating voltage; and

FIG. 9 is a schematic illustration showing a related art X-ray tube.

### DETAILED DESCRIPTION OF THE INVENTION

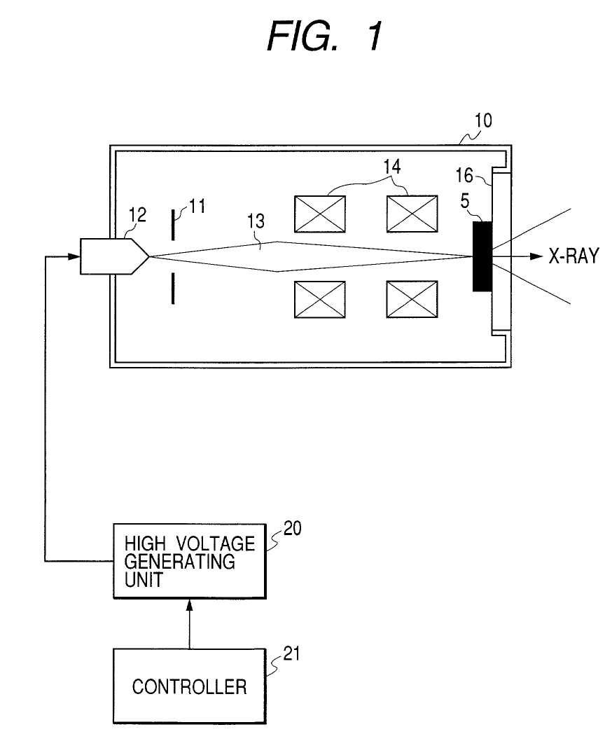

FIG. 1 is a view showing an arrangement of a main portion of an X-ray generator of an embodiment of the present invention. As shown in FIG. 1, an X-ray tube includes an evacuated housing 10, a grid electrode 11, an electron source 12, an electron lens, a multilayer target 5, and an X-ray transmission window 16. The evacuated housing 10 is maintained in a vacuum state. The electron source 12, the electron lens 14 and the multilayer target 5 are arranged in the evacuated housing 10. In the above X-ray tube, after an electron beam 13 has been emitted from the electron source 12 via the grid electrode 11, it is focused by the electron lens 14 so that a focused electron beam can be made. The focused electron beam irradiate to the multilayer target 5 made of different materials.

X-rays are generated from the multilayer target 5 irradiated with the electron beam 13. An X-ray in the thus generated X-rays, which is transmitted through the X-ray transmission window 16 from a side opposite to an incoming side of the electron beam 13, is utilized in air.

A high voltage generating unit 20 supplies a high voltage to the electron source 12, and the high voltage supplied by the high voltage generating unit 20 is appropriately controlled by a controller 21.

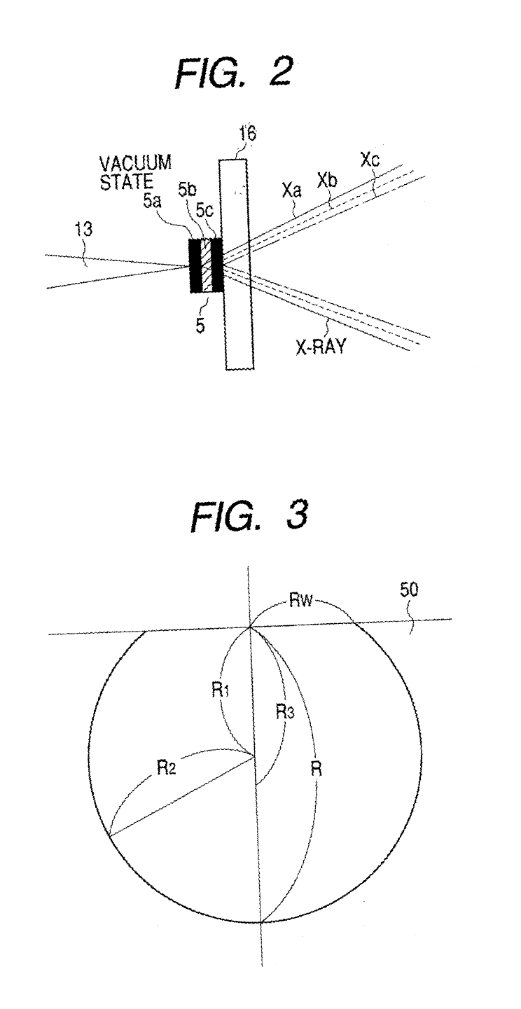

FIG. 2 is an enlarged view showing an X-ray generating section of the X-ray tube in the X-ray generator shown in FIG. 1. In this embodiment, the multilayer target 5 is composed of a first layer 5a, a second layer 5b and a third layer 5c. When the electron beam 13 is incident upon the multilayer target 5, X-rays Xₐ, X_{b} and X_{c}, the radiation qualities of which are different from each other, are generated from multilayer target 5 according to an accelerating voltage of the electron beam 13.

Next, how to select the accelerating voltage of the electron beam 13 to irradiate the multilayer target 5 will be explained below. In this case, in order to simplify the explanation, a target composed of two layers is taken up as an example. FIG. 3 is a view for explaining a diffusion model of electrons proposed by Archard and modified by Kanaya and Okayama. According to the diffusion model, incident electrons proceed into a material 50 by an incident electron depth R1 and then diffuse equally in all directions like a sphere, an electron diffusion radius of which is R2. Here, R3 is a depth of complete diffusion, and R_{w} represents an area of back scattered electrons (BSE) on the surface of the material 50.

In this case, the incident electron depth R1 corresponds to the center of an X-ray generating section, and an X-ray generating region is determined by the electron diffusion radius R2. The incident electron depth R1 and electron diffusion radius R2 are proportional to the maximum depth R. Relations among R, R1 and R2 are expressed by the following equations 1 to 3.

$$R = \frac{\text{2.76} \times {10}^{- 11} A {V}^{5 / 3}}{ρ {Z}^{8 / 9}} \frac{{( 1 + \text{0.978} \times {10}^{- 6} V )}^{5 / 3}}{{( 1 + \text{0.957} \times {10}^{- 6} V )}^{4 / 3}} [ cm ] \qquad \text{[Equation 1]}$$

Wherein ρ: density (g/cm³), Z: atomic number, A: atomic weight, V: accelerating voltage (volt)

$$R1 = \frac{1 + 2 y - 0.21 {y}^{2}}{2 ( 1 + {y}^{2} )} R , γ = 0.187 {Z}^{2 / 3} \qquad \text{[Equation 2]}$$

R2=R−R1 [Equation 3]

R in Equation 1 is expressed by the product of the term, which is determined by the physical property of the target, and the term Rv(v) which is determined by the accelerating voltage V (volt) of the electron beam 13. Rv(V) is expressed by the following equation.

$$Rv ( V ) = \frac{{( 1 + \text{0.978} \times {10}^{- 6} V )}^{5 / 3}}{{( 1 + \text{0.957} \times {10}^{- 6} V )}^{4 / 3}} {V}^{5 / 3} \qquad \text{[Equation 4]}$$

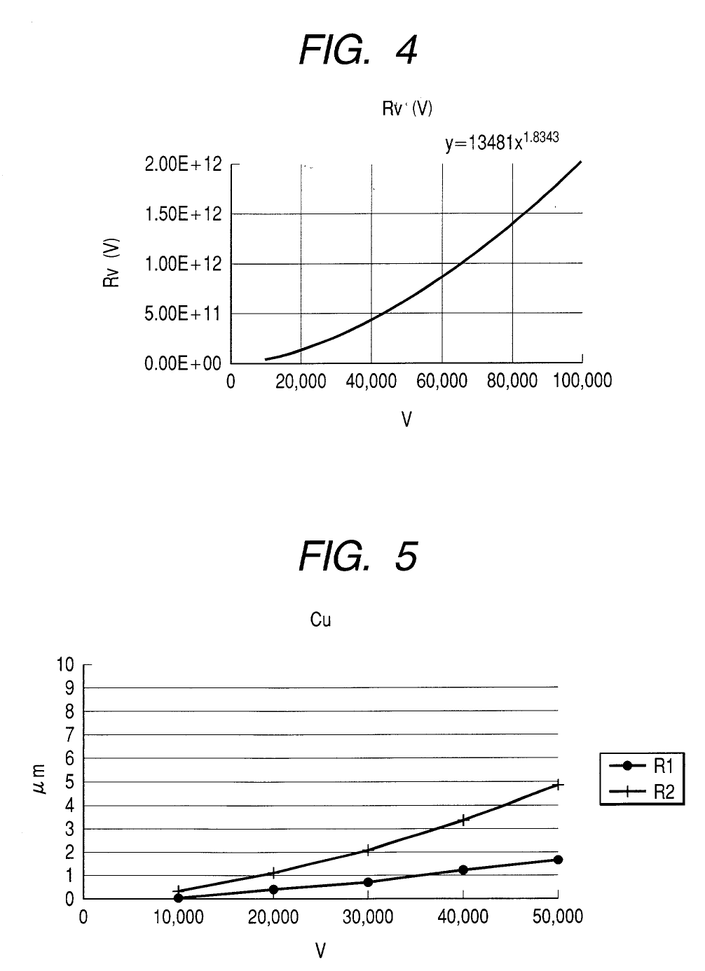

On the graph shown in FIG. 4, the axis of abscissa expresses the accelerating voltage V, and the axis of ordinate expresses Rv(V), and a relation between the accelerating voltage V and Rv(V) is found by Equation 4. As can be seen in FIG. 4, Rv(V) increases being substantially proportional to the accelerating voltage V, that is, the maximum depth R increases being substantially proportional to the accelerating voltage V. In the same manner, R1 and R2 increase being substantially proportional to the accelerating voltage V.

According to the relations expressed by the above Equations 1 to 3, in the case where copper (Cu) target (ρ: 8.92, Z: 29, A: 63.6) is used as the material 50, relations among the accelerating voltage V, the incident electron depth R1 and the electron diffusion radius R2 are expressed on the graph of FIG. 5. In this connection, on the graph of FIG. 5, the axis of abscissa expresses the accelerating voltage, and the axis of ordinate expresses the incident electron depth R1 and the electron diffusion radius R2.

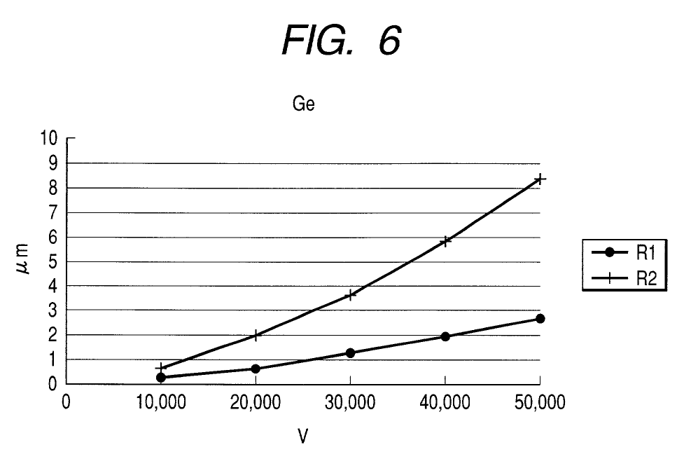

On the other hand, FIG. 6 is a graph showing relations among the accelerating voltage V, the incident electron depth R1 and the electron diffusion radius R2 in the case where germanium (Ge) target (ρ: 6.46, Z: 32, A: 72.6) is used as the material 50. In this connection, on the graph of FIG. 6, the axis of abscissa expresses the accelerating voltage, and the axis of ordinate expresses the incident electron depth R1 and the electron diffusion radius R2.

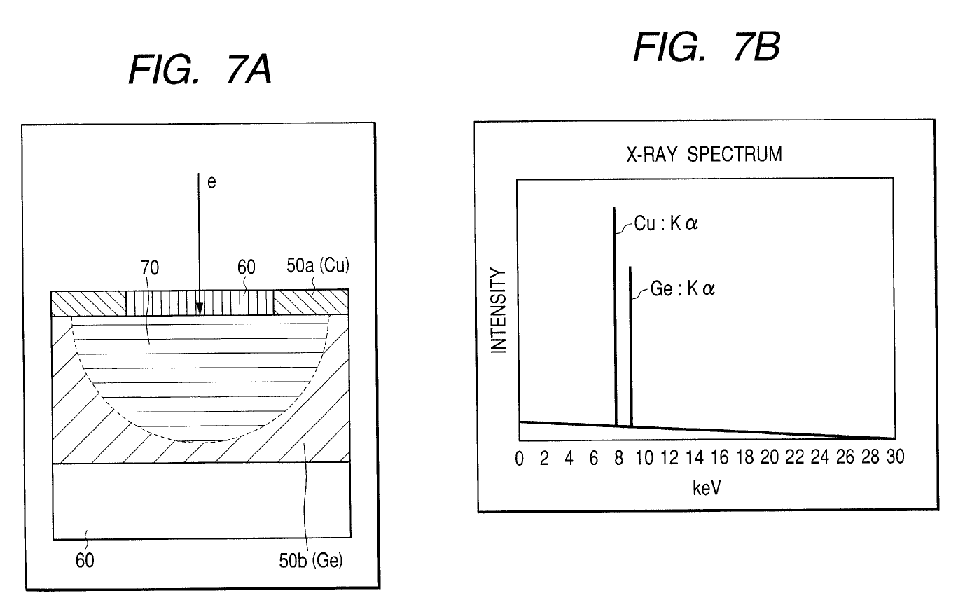

As shown in FIG. 7A, as a target used in this embodiment, there is provided a multilayer target composed of a Ge thin layer 50b of 4.0 μm thickness, which is formed on the X-ray transmission window 16, and a Cu thin layer 50a of 0.704 μm thickness which is formed on the Ge thin layer 50b, or on the incoming side of the electrons. In this case, when the accelerating voltage of incident electrons is 30 kV, as shown in FIG. 5, a position, the incident electron depth R1 of which is 0.704 μm, is located at the substantial center of the X-ray generating section, and the electron diffusion radius R2 is 2.073 μm. Therefore, an X-ray generating region on the Cu thin layer 50a becomes a portion represented by a region 60 as shown in FIG. 7A.

On the other hand, when the accelerating voltage of incident electrons is 30 kV, in the case of germanium (Ge), the electron diffusion radius R2 is 3.600 μm. Therefore, an X-ray generating region on the Ge thin layer 50b becomes a region 70 shown in FIG. 7A.

FIG. 7B is a prediction graph of an X-ray spectrum generated when the multilayer target shown in FIG. 7A is irradiated with electrons, the accelerating voltage of 30 kV. On the graph shown in FIG. 7B, the axis of abscissa expresses the bremsstrahlung X-rays of copper (Cu) and germanium (Ge), and the axis of ordinate expresses the characteristic X-rays of copper (Cu) and germanium (Gc). As shown in FIG. 7B, the X-ray spectrum (bold line on the graph) of bremsstrahlung of copper (Cu) and that of bremsstrahlung of germanium (Ge) are seldom different from each other. However, the generated X-rays contain the characteristic X-rays Kα (about 8 KeV) of copper (Cu) and the characteristic X-rays Kα (about 9 KeV) of germanium (Ge).

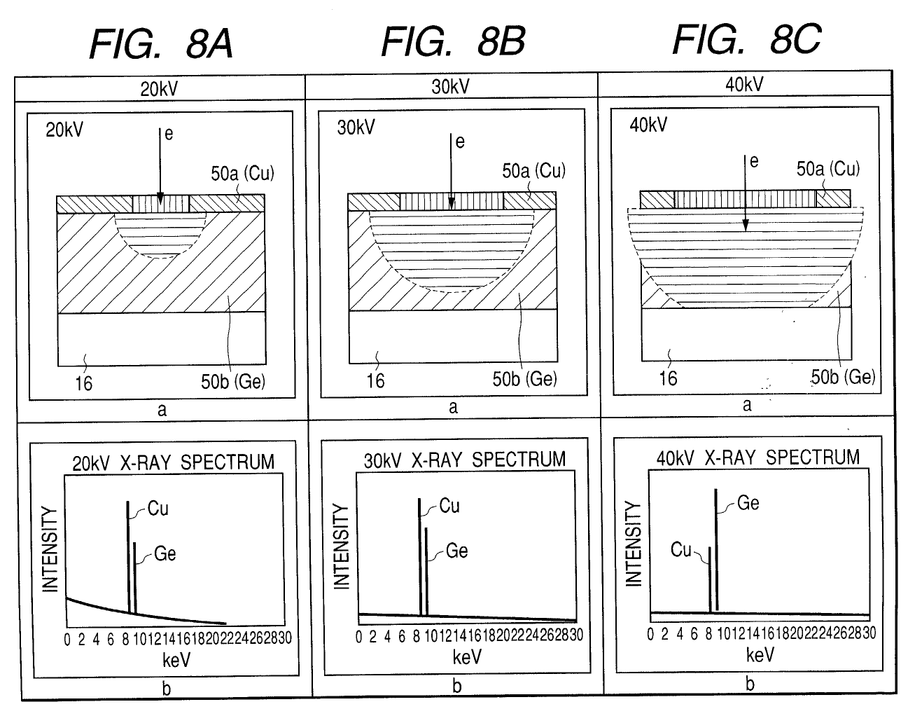

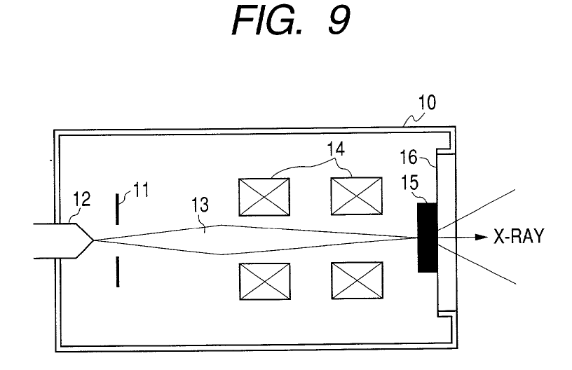

Next, in the multilayer target shown in FIG. 7A, when the accelerating voltage of incident electrons is 20 Kv and 40 KV, as shown on the graphs of FIGS. 5 and 6, it can be considered that X-ray generating regions and X-ray spectrums are shown by FIGS. 8A-a, 8A-b, 8C-a and 8C-b. In this connection, FIGS. 8B-a and 8B-b show the X-ray generating region and the X-ray spectrum in the case where the accelerating voltage of incident electrons is 30 kV in the same manner as that shown in FIG. 7A.

In the case shown in FIG. 8A-a, the incident electron depth R1 is located in the Cu thin layer 50a. Therefore, as shown in FIG. 8A-b, an intensity of the characteristic X-rays of copper (Cu) can be relatively increased as compared with a case in which the accelerating voltage is 30 kV.

In the case shown in FIG. 8C-a, the incident electron depth R1 is located in the Ge thin layer 50b. Therefore, as shown in FIG. 8C-b, an intensity of the characteristic X-rays of germanium (Ge) can be relatively increased as compared with a case in which the accelerating voltage is 30 kV.

As described above, in the X-ray generator shown in FIG. 1, when the accelerating voltage to be supplied to the electron source 12 is appropriately changed, it is possible to variously change the radiation qualities of generated X-rays. In this connection, the accelerating voltage to be supplied to the electron source 12 is determined by the material and its layer thickness used for the target, and also determined by the relations among the accelerating voltage, the incident electron depth R1 and the electron diffusion radius R2, which are found according to the material to be used shown in FIGS. 5 and 6. The accelerating voltage may be appropriately selected according to the sample to be inspected.

When the first layer 5a, the second layer 5b and the third layer 5c shown in FIG. 2 are formed, for example, metal, the melting temperature of which is high, for example, tungsten (W) having the melting temperature of 3400° C., molybdenum (Mo) having the melting temperature of 2620° C., or titanium (Ti) having the melting temperature of 1667° C., is formed into the first layer 5a on the incoming side of the electrons. The second layer 5b and third layer 5c, which are located near the incoming side of the electrons but farther from the incoming side of the electrons than the first layer 5a, are made of metal, the melting temperature of which is low, for example, made of copper (Cu) having the melting temperature of 1083° C., or germanium (Ge) having the melting temperature of 959° C. Due to the foregoing, it is possible to protect the target, more specially, the layer made of metal having the low melting temperature, which is located near the incoming side of the electrons but farther from the incoming side of the electrons than the layer made of metal having the high melting temperature.

When the electron beam power is low, heat generated on the heated thin layer inside is half absorbed by the first metal layer 5a, the melting temperature of which is high, so that an increase in the temperature of the entire target can be suppressed. On the other hand, when the electron beam power is high and even if the second and third layers 5b, 5c made of metal having the low melting temperature and arranged near the incoming side of the electrons but farther the incoming side of the electron than the first layer 5a are heated to a melting temperature, the surface layer made of the high melting temperature metal such as tungsten (W) is not melted. Therefore, vaporization caused by the melting of the low melting temperature metal of the layer arranged near the incoming side of the electrons but farther the incoming side of the electron than the layer made of metal having the high melting temperature can be suppressed. Accordingly, the entire target can be prevented from being damaged.

In the above embodiment, each layer of the multilayer target is made of pure metal such as tungsten (W), molybdenum (Mo), titanium (Ti), germanium (Ge) and copper (Cu) . However, the first layer 5a, the second layer 5b and the third layer 5c may be made of another metal such as gold (Au), argentum (Ag), platinum (Pt), palladium (Pd), tantalum (Ta), nickel (Ni), etc. Further, each layer may be made of compound such as diamond, graphite, magnesium oxide (MgO), beryllium oxide (BeO), boron nitride (BN), ceramics, alumina (Al2O3), silicon nitride (SiN), aluminum silicon carbide (AlSiC), aluminium nitride (AlN), silicon carbide (SiC), etc. Moreover, each layer may be made of alloy such as rhenium-tungsten (W, Re) alloy, tungsten-molybdenum (W, Mo) alloy, silver-palladium (Pd, Ag) alloy, phosphor bronze (Cu, Sn) or copper-tungsten (W, Cu) alloy.

The multilayer target can be easily manufactured by a well known layer making device such as a vacuum vapor-deposition device or spatter layer making device. For example, in the vacuum vapor-deposition device, after a base plate such as an aluminum plate, which can be used as an X-ray transmission window, is set, metal vapor of Ge, which is a source of vapor deposition and generated when Ge is heated by electron beams, is blown onto the base plate so as to make a thin layer of Ge. Next, the source of vapor deposition is exchanged to Cu, and Cu is heated by electron beams and the thus generated vapor of Cu is blown onto the base plate so as to make a thin layer of Cu. As a result, layers of Ge and Cu can be formed on the X-ray transmission window.

In the above embodiment, the transmission type X-ray tube and X-ray generator are explained , However, it should be noted that the present invention is not limited to the above specific embodiment. For example, the present invention can be applied to a reflection type X-ray tube and X-ray generator.

According to the present invention, the target is composed of a multilayer made of different materials. Therefore, X-rays, the radiation qualities of which are different, can be generated.

The layer of the target on the electron incoming side is made of metal, the melting temperature of which is high. Therefore, it is possible to prevent the metal, the melting temperature of which is low, of the layer arranged near the incoming side of the electrons but farther the incoming side of the electron than the layer made of metal having the high melting temperature from melting, and life of the target can be extended.

Further, when the accelerating voltage of electrons irradiated to the target is appropriately changed, an incident depth of electrons upon the target, which is composed of a multilayer, can be adjusted. Therefore, it is possible to generate X-rays of various radiation qualities.

What is claimed is:

1. An X-ray tube comprising:
an electron source for applying electrons; and
a target for generating X-rays based on the electrons applied from said electron source and incident upon said target, said target including a multilayer made of different materials.

2. The X-ray tube according to claim 1, wherein the multilayer includes at least two layers in which one of the layers located closer to an incoming side of the electrons than the other has a melting temperature higher than that of the other of layers.

3. The X-ray tube according to claim 2, wherein the multilayer includes first and second layers which are arranged in order from the incoming side of the electrons, the first layer being made of tungsten, the second layer being made of copper.

4. The X-ray tube according to claim 2, wherein the multilayer includes first, second and third layers which are arranged in order from the incoming side of the electrons, the first layer being made of tungsten or molybdenum, the second layer being made of copper, the third layer being made of germanium.

5. An X-ray generator comprising:
an X-ray tube having an electron source for applying electrons, and a target for generating X-rays based on the electrons applied from said electron source and incident upon said target, said target including a multilayer made of different materials; and
a high voltage generating unit for supplying a different high voltage to said electron source according to the target.

6. The X-ray generator according to claim 5, further comprising:
a controller for controlling said high voltage generating unit to supply the different high voltage according to the multilayer target.

7. The X-ray generator according to claim 5, wherein the multilayer includes at least two layers in which one of the layers located closer to an incoming side of the electrons than the other has a melting temperature higher than that of the other of the layers.
